(19) United States
(12) Patent Application Publication
(10) Pub. No.: US 2007/0048554 A1
(43) Pub. Date: Mar. 1, 2007

(54) Reflective rope, hangers, cables, lifelines and methods for making the same

(76) Inventors: William J. B. Jacobs, Sylvester, WV (US); Mark W. Jacobs, Charleston, WV (US); Timothy Callaway, Mount Airy, NC (US)

Correspondence Address: MEYER UNKOVIC & SCOTT LLP, 1300 OLIVER BUILDING, PITTSBURGH, PA, 15222, US

(21) Appl. No.: 11/287,747

(22) Filed: Nov. 28, 2005

Related U.S. Application Data
(60) Provisional application No. 60/710,359, filed on Aug. 23, 2005.

(51) Int. Cl. B66C 1/12; D03D 15/00; D03D 15/12; A47H 13/00

(52) U.S. Cl. 428/920; 428/921; 442/301; 442/302; 24/716; 294/74

(57) ABSTRACT

The present invention discloses reflective ropes, hangers, cables, and lifelines and methods for making them.

### CROSS REFERENCE TO RELATED APPLICATION

This application is a nonprovisional application, which claims the benefit of the provisional patent application of the same title and same inventors, which was filed on Aug. 23, 2005 and assigned U.S. Patent Application Ser. No. 60/710,359.

### BACKGROUND OF THE INVENTION

Mining is inherently dangerous. Miners are under constant threat of a collapse or an accident within the mines. Often the lighting in the mines is low or nonexistent, making quick escapes from the mines very difficult. Additionally, within a mine there may be numerous tunnels and pathways, only a few of which lead directly to the outside. Mining tunnels tend to be very dark and, in the event of a fire, smoke can also make visibility difficult. In an emergency situation, even experienced miners may lose their directional and become lost. Getting lost in a mine in an emergency situation can result in serious injury and/or death.

The mining industry constantly is searching for equipment to make mining safer. One such goal has been to incorporate reflective materials into mine-related equipment to aid miners in finding their way through the tunnels, particularly but not exclusively, in emergency situations. The present invention addresses this need and others by disclosing a reflective rope for use in mines.

One type of mine equipment that has been developed to increase mine safety is a safety directional line (or lifeline) for underground mining. One example of such a line is described in U.S. Pat. No. 5,988,101 to Jacobs, et al. These lines come in a variety of sizes, shapes, embodiments, etc. and are followed by miners to lead them to various places in the mine, outside of the mine, and/or to safety. Often these lines are made of a rope or cable with indicators along the line at given distances to comply with local requirements and regulations. Historically, it has been difficult to design reflective lifelines that also satisfy the other mining requirements, such as strength, nonflammability, nonconductivity, etc.

Additionally, many industries, including but not limited to the mining industry, require some means of temporarily supporting or suspending various articles for various purposes, and often have need of a simple yet durable and reflective strap or loop which may be used as a hanger for various parts and components. Often it is advantageous to have such a reflective hanger, strap, or loop (collectively referred to herein as a “hanger”) so that it can be seen easily in low light conditions. Some examples of various hangers and loops are described in U.S. Pat. Nos. 5,970,697 and 5,871,193, both issued to Jacobs, et al. Until the invention of present reflective rope, no reflective rope products of the types described herein were available to the mining community. The present invention addresses this need for reflective ropes and hangers.

### SUMMARY OF THE INVENTION

One embodiment of the present invention discloses a reflective rope for use in the mining industry comprising the combination of at least one carrier of rope material and at least one reflective material.

Another embodiment of the present invention discloses a reflective rope for use in the mining industry comprising at least one carrier of rope material and at least one reflective material, which are combined into one of the following forms: a hollow braided rope (a braided rope with a hollow center), a solid braided rope, a twisted braided rope, or a plaited rope.

Another embodiment of the present invention encompasses a method of making a reflective rope comprising braiding together at least two carriers of material, wherein at least one carrier comprises a reflective yarn comprising 0.5 mm glass beads bonded to polyester filament, in such a manner as to have at least two pics per inch of length.

One embodiment of the present invention encompasses a method of making a reflective rope for use in the mining industry comprising combining at least one carrier of rope material and at least one reflective material.

One embodiment of the present invention encompasses a method of making a reflective rope for use in the mining industry comprising braiding into the form of a hollow braid eight carriers of monofilament flame retardant polypropylene, so as to have at least two pics per inch of length, wherein two of the eight carriers are marker carriers, and blending a reflective material into these two marker carriers.

Another embodiment of the present invention discloses a safety directional line comprising a reflective rope made from the combination of at least one carrier of rope material and at least one reflective material. A plurality of directional indicators are spaced evenly along the rope and positioned such that the indicators are pointing along the axis of the line.

Another embodiment of the present invention discloses an improved safety directional line for underground mining comprising a reflective rope, a pair of fasteners for attaching the rope to a wall, and a plurality of directional indicators, each of which comprises two identical cone-forming sections. Each cone-forming section has a first end and a second end, a first side wall extending outwardly from the first end to the second end defining a half-conically shaped surface, a second side wall having a flat surface opposite the conically shaped surface, wherein the cone forming section is semicircular in cross section; and wherein the second side wall is provided with a channel therein extending along the length of the cone-forming section from the first end to the second end, a semicircular end plate having a circular edge and a flat edge integrally formed with the second side wall and having a section removed from the flat edge which is concentric with the channel in the second side wall of the cone-forming section, a plurality of receptor holes along the first side wall and corresponding holes along the channel in the flat surface, a plurality of retaining pins for insertion into the receptor holes, a coupler for joining the cone-forming sections of each indicator, whereby, upon joining the cone-forming sections of each indicator such that the second side walls, and the first ends and the second ends are adjacent, the coupler is engaged and the cone-forming sections of each of the indicators form a continuous side wall which extends outwardly from the first end to the second end defining a conical outer configuration and an inner wall which defines a circular channel extending through the center of the indicator. The rope is inserted into the circular channel of each indicator and the retaining pins are inserted in the receptor holes and the holes along the channel and engage the rope.

Another embodiment of the present invention discloses an improved line with double spliced loops formed therein for suspending articles therefrom, comprising a length of reflective rope having a plurality of first diagonal directional carriers interwoven with a plurality of second diagonal directional carriers, a first end portion, and an opposite second end portion. Each end portion has a first connecting portion and a second connecting portion mating with the first connecting portion for forming a closed loop. Each first connecting portion passes diametrically through the corresponding second connecting portion at a first point thereon to form the closed loop and thereby define an intersecting portion, and thence each first connecting portion is inserted into the corresponding second connecting portion at a second point thereon and diametrically passed through the first connecting portion at the intersecting portion to form a knot, such that each first connecting portion passes concentrically through the corresponding second connecting portion to be captured therein. Each second point is separated from the corresponding first point by at least one of the first directional carriers and at least one of the second directional carriers immediately adjacent to at least one of the first directional carriers, with at least one of the first directional stands crossing over at least one of the second directional carriers. Each closed loop is connected to one another by an intermediate portion.

Another embodiment of the present invention discloses an improved hanger for temporarily suspending articles therefrom, comprising a length of reflective rope having a plurality of first diagonal directional carriers interwoven with a plurality of second diagonal directional carriers, and a first connecting portion with a first end and an opposite second connecting portion with a second end. The first connecting portion is positioned diametrically through the second connecting portion at a first point thereon and thence into the second connecting portion at a second point thereon, provided with a locking interweave of carriers about which a first connecting portion knot is formed, then inserted diametrically through an intersecting portion of the first connecting portion within the hollow core of the second connecting portion and concentrically through the second connecting portion to be captured therein. The second point being separated from the first point by at least one of the first directional carriers and at least one of the second directional carriers immediately adjacent to at least one of the first directional carriers, with at least one of the first directional carriers crossing over to at least one of the second directional carriers. The second connecting portion passes into the first connecting portion at a second connecting portion entrance point thereon providing with a locking interweave of carriers about which a first connecting portion knot is formed, then inserting diametrically through an intersecting portion of the first connecting portion within the hollow core of the second connecting portion and being captured concentrically within the first connecting portion to form a closed loop of increasing strength with increasing tensile force upon the closed loop. The rope comprises at least one carrier of rope material and at least one reflective material, which are combined into one of the following forms: a hollow braided rope, a solid braided rope, a twisted braided rope, or a plaited rope.

Another embodiment of the present invention is a hanger comprising a rope made of at least two carriers of rope material, which are braided together, and wherein at least one carrier comprises a reflective yarn made of about 0.5 mm glass beads bonded to polyester filament.

Another embodiment of the present invention is a hanger for use in the mining industry comprising the combination of at least one carrier of rope material and at least one reflective material.

Another embodiment of the present invention comprises a method of making a safety directional line comprising braiding together at least one carrier of rope material and a reflective yarn comprising about 0.5 mm glass beads bonded to polyester filament, in such a manner as to have at least two pics per inch of length. Additionally, a plurality of directional indicators are attached at even spaces along the rope and positioned such that the indicators are pointing along the axis of the line.

Another method of making a safety directional line for use in the mining industry according to the present invention comprises combining at least one carrier of rope material and at least one reflective material and attaching a plurality of directional indicators spaced evenly along the rope and positioned such that the indicators point along the axis of the line.

Another embodiment of the present invention is a method of making an improved line with double spliced loops formed therein for suspending articles therefrom, which comprises the following steps: (i) weaving a length of reflective hollow braided rope having a plurality of first diagonal directional carriers with a plurality of second diagonal directional carriers, a first end portion, and an opposite second end portion; (ii) mating each of the end portions having a first connecting portion and a second connecting portion mating with said first connecting portion for forming a closed loop; (iii) each said first connecting portion passing diametrically through the corresponding said second connecting portion at a first point thereon to form said closed loop and thereby define an intersecting portion, and (iv) thence each said first connecting portion being inserted into said corresponding second connecting portion at a second point thereon and diametrically passed through said first connecting portion at said intersecting portion to form a knot, such that each said first connecting portion passes concentrically through said corresponding second connecting portion to be captured therein. Each second point is separated from the corresponding said first point by at least one of the first directional carriers and at least one of the second directional carriers immediately adjacent the at least one of the first directional carriers, with the at least one of the first directional carriers crossing over the at least one of the second directional carriers, and each closed loop being connected to one another by an intermediate portion.

The present invention also includes a method of making an improved hanger for temporarily suspending articles therefrom, comprising the steps of: (i) weaving a length of hollow braided reflective rope having a plurality of first diagonal directional carriers with a plurality of second diagonal directional carriers, and a first connecting portion with a first end and an opposite second connecting portion with a second end; (ii) positioning the first connecting portion through the second connecting portion at a first point thereon and thence into the second connecting portion at a second point thereon, provided with a locking interweave of carriers about which a first connecting portion knot is formed, then inserting diametrically through an intersecting portion of the first connecting portion within the hollow core of the second connecting portion and concentrically through the second connecting portion to be captured therein; (iii) separating the second point from the first point by at least one of the first directional carriers and at least one of the second directional carriers immediately adjacent the at least one of the first directional carriers, with the at least one of the first directional carriers crossing over the at least one of the second directional carriers; and (iv) passing the second connecting portion into the first connecting portion at a second connecting portion entrance point thereon providing with a locking interweave of carriers about which a first connecting portion knot is formed, then inserting diametrically through an intersecting portion of the first connecting portion within the hollow core of the second connecting portion and being captured concentrically within the first connecting portion to form a closed loop of increasing strength with increasing tensile force upon the closed loop, wherein the rope comprises at least two carriers of rope material and at least one reflective material, which are combined into a form selected from the group consisting of a hollow braided rope, a solid braided rope, a twisted braided rope, and a plaited rope.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 illustrates two embodiments of a reflective rope according to the present invention;

FIGS. 2 and 3 illustrate various reflective hangers made according to various embodiments of the present invention;

FIG. 4 illustrates one embodiment of a lifeline that can be made from rope according to the present invention;

FIG. 5 illustrates one embodiment of a line that can be made from rope according to the present invention;

FIG. 6 illustrates one embodiment of a hanger that can be made from rope according to the present invention; and

FIG. 7 illustrates another embodiment of a hanger that can be made from rope according to the present invention.

### DESCRIPTION OF THE INVENTION

Various embodiments of the present invention comprise reflective ropes, the methods of making and manufacturing these ropes, and various methods of making and devices for using the reflective ropes, including but not limited to, in lifelines, lines, hangers, cables, etc. as described more fully herein.

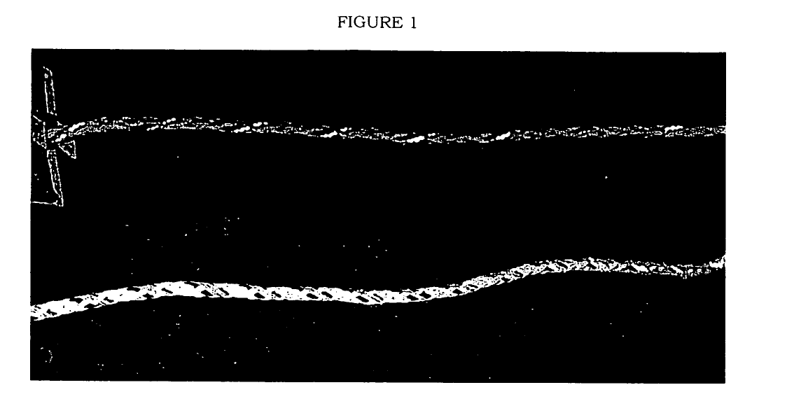

One embodiment of the present invention is a reflective rope (10) comprising a braid as shown in FIG. 1. The rope (10) comprises a rope material and a reflective material in one of the following forms, or any other equivalent form: a hollow braided rope (a braid with a hollow center), a solid braided rope, a twisted braided rope, or a plaited rope.

In the preferred embodiment, the reflective rope (10) is a hollow braid consisting of eight carriers or bundles of monofilament flame retardant polypropylene, or an equivalent material. It will be known to those in the art, that carriers are comprised of one or more strands of a material. In the preferred embodiment of the present invention, the number of strands in a carrier is between twenty and sixty strands. Any number of strands and any number of carriers, which create a rope to satisfy its intended use, may be used to make the present invention reflective rope, and all such variations are included within the scope of this invention. The suggested number of strands and carriers help to define the preferred embodiment of the present invention rope, but are not intended to limit the rope to those numbers. For ease of discussion, the term “carriers” is used herein to mean any number of strands of a material or a bundle of strands, as described previously.

One preferred embodiment uses a reflective yarn, specifically about 0.5 mm glass beads bonded to polyester filament, as the reflective material. Also in a preferred embodiment, a flame retardant is added to the rope (10) to make it flame resistant. The rope (10) may consist of any number of carriers, but eight carriers have been found to work best. In the preferred embodiment of the present invention, the reflective material is blended into two carriers (preferably two marker carriers) with the polypropylene to maintain the flame retardant nature as well as strength of the carrier for braiding. In the preferred embodiment of the present invention, the reflective rope (10) is non-conductive and flame retardant.

One embodiment of the present invention is a reflective rope (10) for use in the mining industry comprising a hollow braid of eight carriers of monofilament flame retardant polypropylene. The rope (10) is assembled to have at least two pics per inch of length. In the preferred embodiments, the rope (10) will have two, three, or four pics per inch of length. Two of the eight carriers are marker carriers and a reflective material is blended into those two marker carriers. The preferred reflective material for this embodiment of a reflective rope (10) comprises a reflective yarn made of about 0.5 mm glass beads bonded to polyester filament, but it will be apparent to those in the art that other reflective materials may work as well. As described more fully below, any of the above-described embodiments of this rope (10) can be made into lifelines, hangers, cables, lines, etc. for use in the mining industry.

The present invention also comprises a method of making a reflective rope (10). In the preferred embodiment of this method, the combination is of at least one carrier of rope material and at least one reflective material into a form selected from the group consisting of a hollow braided rope, a solid braided rope, a twisted braided rope and a plaited rope. The preferred embodiment of this method comprises assembling the materials in such a manner as to have at least two, but preferably two, three, or four, pics per inch of length, so that the material may be spliced easily. Other embodiments for assembling the rope (10) are possible, will be apparent to those skilled in the art, and are contemplated and encompassed by this invention. Again, in the preferred embodiment of the method, the reflective material is blended into two carriers (preferably two marker carriers) with the polypropylene to maintain the flame retardant nature as well as strength of the carrier for braiding. The preferred reflective material presently can be purchased from King Tech International Corp. of San Diego, Calif. (item number 803304). This preferred reflective material is a reflective yarn, 0.5 mm glass beads bonded to polyester filament. It will be obvious to those skilled in the art that other reflective materials will satisfy the criteria described herein, may be used, and are encompassed by the present invention.

The method according to the present invention can be used to make any of the above-described variations of reflective rope (10) including, but not limited to, polypropylene rope (10), flame retardant rope (10), nonconductive rope (10), rope (10) with reflective material blended into the marker carriers, etc.

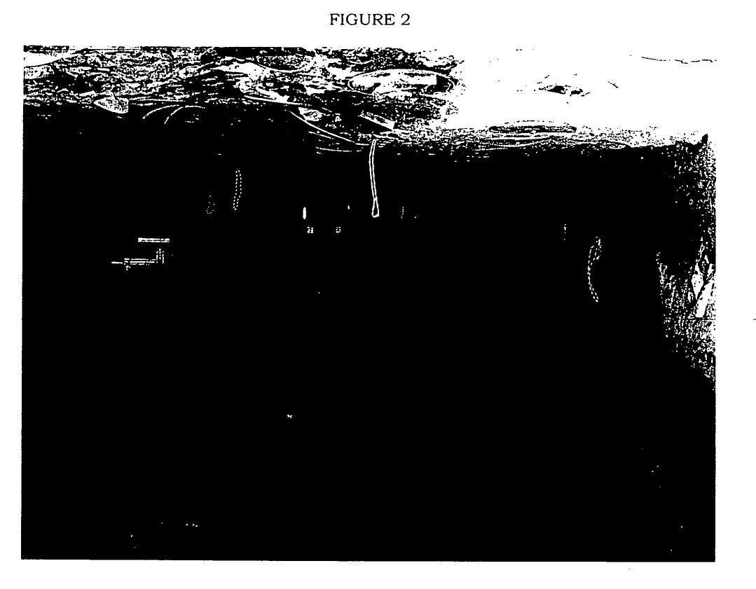

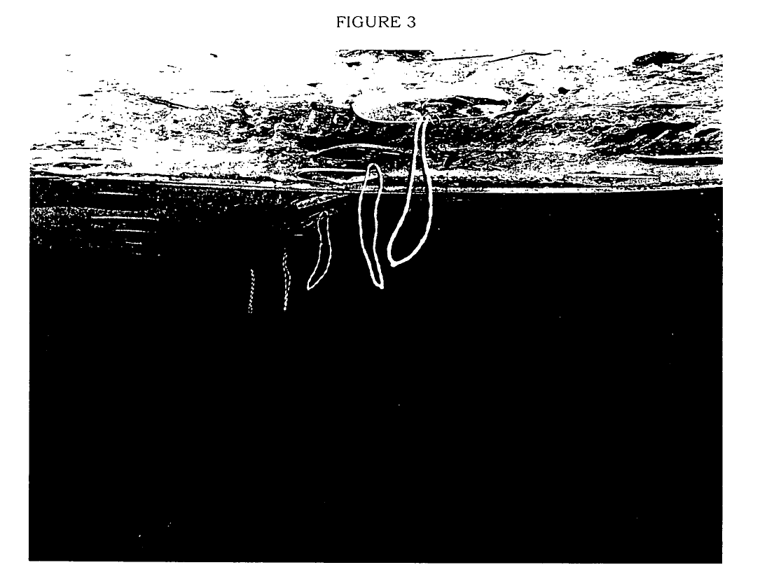

The rope (10) construction is preferably braided, but includes any method of combining carriers, such as braiding, twisting, or plaiting, in such a manner so as to incorporate a reflective material into the rope (10). Within the mining industry, the rope (10) may be used in, among other things, lifelines, cables, or hangers, but it will be apparent to those in the art that the rope may be used in a variety of industries and a variety of products that call for reflective rope material. FIGS. 2 and 3 show some lines, cables and/or hangers made of reflective rope of the present invention.

One embodiment of the present invention also comprises a safety directional line (20) for underground mining operations that is made from any of the above-described reflective ropes and/or by any of the above-described methods. One embodiment of a safety directional line (also known as a lifeline) (20) according to the present invention comprises a reflective rope made of at least one carrier of rope material and at least one reflective material, which are combined in one of the following forms, or an equivalent form: a hollow braided rope, a solid braided rope, a twisted braided rope, or a plaited rope. A plurality of directional indicators (21) are spaced along the rope (10) and positioned such that the directional indicators (21) are pointing along the axis of the line (20).

Another embodiment of the present invention is an improved safety directional line (20) for mining operations. This safety directional line (20) has a first end and a second end and comprises a reflective rope and a plurality of directional indicators (21). The reflective rope (10) can be made according to any of the above-identified variations, embodiments, and methods.

For one embodiment of an improved safety directional line (20) the directional indicators (21) have a first end and a second end and comprises two identical cone forming sections, which have a conically shaped side wall on one side and an opposite flat side wall, forming half cone-shaped cavity therein. The flat side wall is provided with a semicircular channel therein which extends from the first end to the second end. There is a semicircular end plate integrally formed with the cone forming section on the second end. There is a semicircular section defined on the end plate, which is concentric with the channel on the flat side wall. There are a series of receptor holes along the conical side wall and corresponding holes along the channel in the flat side wall for receiving retaining pins. The two cone-forming sections are removably coupled, whereby the directional indicator (21) has a continuous side wall which extends outwardly from the first end to the second end defining a conical outer configuration and an inner tube which defines a circular channel extending through the center of the directional indicator (21) along its horizontal axis from the first end to the second end. The circular channel is adapted for receiving the rope (10).

Also, for one embodiment of an improved safety directional line (20), the directional indicator (21) is further provided with retaining pins that hold the directional indicator (21) in place along the rope (10). The pins are placed through receptor holes in the side wall and the holes in the channel of the directional indicator (21) and into the rope (10), thereby securing the directional indicator (21) in place.

For one embodiment of an improved safety directional line (20), the two cone-forming sections of the directional indicator (21) are coupled by engaging snap together clips. The clips have a male side and a female side and are known to those skilled in the art. The directional indicator (21) can be easily adjusted along the rope (10) by removing the retaining pins and unsnapping and disengaging the cone-forming sections. This adjustability allows the improved directional safety line (20) to be adapted for compliance with any local code.

The directional indicators (21) of one embodiment of an improved safety directional line (20) are placed on the reflective rope (10) with the first end of the directional indicator (21) facing the first end of the directional line (20) such that when someone is exiting the mine his hand slides along the slope of the directional indicator (21) and meets little resistance due to the gradual slope of the indicator (21) side wall. In the event that the person is traveling the wrong direction, his hand will meet the flat end cap of the indicator (21) and come to an abrupt stop, indicating that he is traveling in the wrong direction.

For one embodiment of an improved safety directional line (20), there is a bronze swivel hook or a fixed hook attached to the second end of the safety line (20) to attach it to the wall of the mine. The first end of the safety line (20) is provided with a bronze ring to attach the safety line (20) to the opposite end of the mine near the entrance. The swivel hook prevents the rope (10) from being tangled. The bronze ring and hook are non-sparking and non-corrosive. The ring and hook need not be placed on the line (20) in this manner, but can alternatively be affixed to either end.

For one embodiment of an improved safety directional line (20), there is fluorescent tape on the directional indicators (21) to make them more visible to one trying to exit the mine. The tape is formed in an “X” on the end plate of the directional indicator (21) indicating that it is the wrong direction of travel to exit the mine. Additionally, the tape is placed parallel to the axis of the directional indicator (21) along the side wall indicating the correct direction of travel.

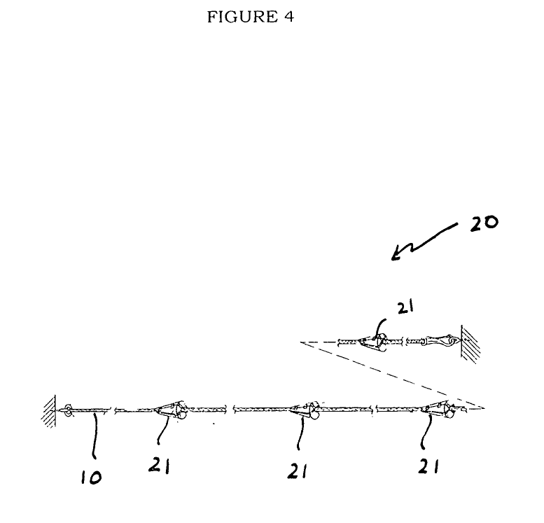

There are many varieties of lifelines (20) on the market today. FIG. 4 illustrates just one type of lifeline (20). The present invention encompasses the use of any of the above-described embodiments of reflective rope (10) with any lifeline (20), not just the embodiment illustrated in FIG. 4. Lifelines (20), in general, are rope-type lines with some device attached to the rope to allow a user to determine whether he/she is heading in the correct direction by feeling his/her way along the lifeline (20). The present invention encompasses any and all lifelines (20) that incorporate a reflective rope (10) according to the present invention.

The reflective rope (10) of the present invention can be used as three cone reflective spur line indicators in conjunction with hangers to designate cut-throughs, intersections, crib rooms, rescue equipment, first aid areas, and safety directional lines and all other forms of lifelines used in the mining industry to enhance the visibility for escape routes. The reflective rope (10), and devices made therefrom, will be used for rope droppers in engaging or retrieving where the safety directional lines or lifeline system is attached/tied to the roof for vehicle transport purposes. The dropper is attached to the lifeline at regular intervals, allowing the lifeline to be broken away from the roof when required by pulling down the rope dropper.

It will be obvious to one skilled in the art that the various embodiments of reflective rope (10) and methods of making the same according to the present invention can be used with any type of lifeline, hanger, and/or cable that is currently on the market or developed in the future, not just the preferred embodiments described and shown herein. All of those embodiments are contemplated as being a part of the present invention.

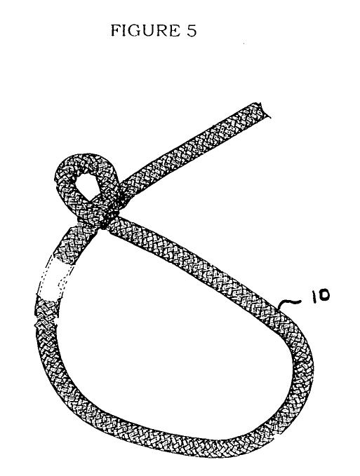

Another embodiment of the present invention comprises a reflective rope (10) according to any of the above-identified embodiments of reflective ropes (10) and/or methods of making the same, forming an improved line having integral first and second closed loops spliced therein at each end thereof, with an intermediate length extending there between, for use in tying off or suspending various articles. An example of the present line is shown in FIG. 5. This line is well suited for use in the underground mining industry for tying off cables from continuous miner machinery, or for supporting or suspending articles such as electrical cables, hydraulic and pneumatic lines, ventilation ducts, etc. from the roof or along the wall of a mine drift to keep such articles clear of the drift floor. The lines may be suspended by S-hooks or other suitable article attachment means, or looped about another article and secured, e.g. by means of a girth hitch as shown around the cables.

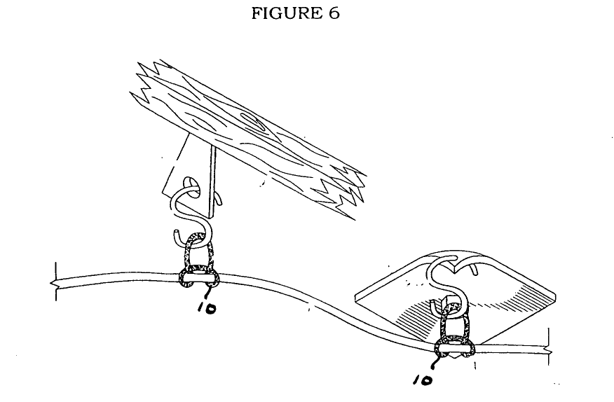

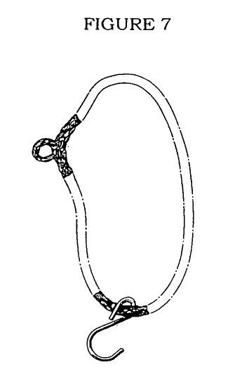

Another embodiment of the present invention comprises a reflective rope hanger for use in temporarily suspending various articles, with examples of two embodiments of the present hangers and their function being shown in FIGS. 6 and 7. In general, a mining hanger consists of some sort of hook connected to a rope or loop to suspend or hang items within a mine. The hangers are well suited for use in the underground mining industry for supporting articles such as electrical cables, hydraulic and pneumatic lines, ventilation ducts, etc. from the roof or along the wall of a mine drift to keep such articles clear of the drift floor. The hangers may be suspended by S-hooks or other suitable article attachments, with the S-hooks or other means in turn being removably secured to a conventional spike imbedded in a mine timber, or hooked to the corner of a conventional roof plate or otherwise suspended.

In the preferred embodiment of the hanger, each of the reflective hanger loops is formed to have a diameter on the order of six inches or so when laid out in a circular configuration, in order to position any articles suspended therefrom well away from the opposite side of the loops which may be connected to a metal object. This precludes any arcing of electrical energy between the article suspended within the loops, such as the cable, and a grounded potential. The present hanger loops may be formed of virtually any diameter material, in virtually any size desired, and by a variety of methods, all of which are encompassed by this invention.

It will be seen that the use of an essentially pure, non-metallic fiber such as polypropylene, also provides an electrically non-conductive rope, lifeline, cable, line and/or hanger due to the electrically insulating properties of such materials, particularly synthetic plastic materials. This provides important safety benefits when the present hangers are used for the support of electrical equipment, such as electrical cables, etc. in various environments. Accordingly, the various types of snap hooks, D-rings, etc. which may be installed upon the present hanger loops during or after their construction, are preferably formed of materials which are not prone to producing sparks when struck by another object, e.g., non-metallic or bronze materials.

While the present rope hangers are well suited for use in providing temporary support for innumerable different articles in a vast variety of environments, they are particularly well suited for use in the underground mining industry, due to their flame retardant and electrically non-conductive properties. In a preferred embodiment, the present invention hangers, lifelines, cables, etc. may be formed using rope having a relatively bright color or colors in addition to the reflective material, in order to provide optimum visibility in the normally relatively dark conditions found in underground mines.

One embodiment of the present flame resistant, electrically non-conductive hanger provides a useful means of temporarily suspending a variety of different articles in many different industries, such as underground mines, automobile assembly plants, shipyards, etc. The present hangers may be formed using virtually any suitable diameter of rope, depending upon the strength required for the completed hanger. The use of electrically non-conductive and flame resistant materials, as well as reflective material and bright and contrasting colors in different carriers of the hanger rope, provides hangers that are safe and durable in virtually any environment of use.

Another embodiment of the present invention discloses an improved line with double spliced loops formed therein for suspending articles therefrom, comprising a length of reflective rope having a plurality of first diagonal directional carriers interwoven with a plurality of second diagonal directional carriers, a first end portion, and an opposite second end portion. Each end portion has a first connecting portion and a second connecting portion mating with the first connecting portion for forming a closed loop. Each first connecting portion passes diametrically through the corresponding second connecting portion at a first point thereon to form the closed loop and thereby define an intersecting portion, and thence each first connecting portion is inserted into the corresponding second connecting portion at a second point thereon and diametrically passed through the first connecting portion at the intersecting portion to form a knot, such that each first connecting portion passes concentrically through the corresponding second connecting portion to be captured therein. Each second point is separated from the corresponding first point by at least one of the first directional carriers and at least one of the second directional carriers immediately adjacent to at least one of the first directional carriers, with at least one of the first directional stands crossing over at least one of the second directional carriers. Each closed loop is connected to one another by an intermediate portion. This improved line may be made from any of the above-identified embodiments of rope.

Another embodiment of the present invention discloses an improved hanger for temporarily suspending articles therefrom, comprising a length of reflective rope having a plurality of first diagonal directional carriers interwoven with a plurality of second diagonal directional carriers, and a first connecting portion with a first end and an opposite second connecting portion with a second end. The first connecting portion is positioned diametrically through the second connecting portion at a first point thereon and thence into the second connecting portion at a second point thereon, provided with a locking interweave of carriers about which a first connecting portion knot is formed, then inserted diametrically through an intersecting portion of the first connecting portion within the hollow core of the second connecting portion and concentrically through the second connecting portion to be captured therein. The second point being separated from the first point by at least one of the first directional carriers and at least one of the second directional carriers immediately adjacent to at least one of the first directional carriers, with at least one of the first directional carriers crossing over to at least one of the second directional carriers. The second connecting portion passes into the first connecting portion at a second connecting portion entrance point thereon providing with a locking interweave of carriers about which a first connecting portion knot is formed, then inserting diametrically through an intersecting portion of the first connecting portion within the hollow core of the second connecting portion and being captured concentrically within the first connecting portion to form a closed loop of increasing strength with increasing tensile force upon the closed loop. The rope comprises at least one carrier of rope material and at least one reflective material, which are combined into one of the following forms: a hollow braided rope, a solid braided rope, a twisted braided rope, or a plaited rope. This improved hanger may be made from any of the above-identified embodiments of rope.

Another embodiment of the present invention is a hanger comprising a rope made of at least two carriers of rope material, which are braided together, and wherein at least one carrier comprises a reflective yarn made of about 0.5 mm glass beads bonded to polyester filament.

Another embodiment of the present invention is a hanger for use in the mining industry comprising the combination of at least one carrier of rope material and at least one reflective material. This hanger may be made from any of the above-identified embodiments of rope.

Another embodiment of the present invention comprises a method of making a safety directional line comprising braiding together at least one carrier of rope material and a reflective yarn comprising about 0.5 mm glass beads bonded to polyester filament, in such a manner as to have at least two pics per inch of length. Additionally, a plurality of directional indicators are attached at even spaces along the rope and positioned such that the indicators are pointing along the axis of the line. This method may be used in conjunction with any of the above-identified embodiments of rope.

Another method of making a safety directional line for use in the mining industry according to the present invention comprises combining at least one carrier of rope material and at least one reflective material and attaching a plurality of directional indicators spaced evenly along the rope and positioned such that the indicators point along the axis of the line. This method may be used in conjunction with any of the above-identified embodiments of rope.

Another embodiment of the present invention is a method of making an improved line with double spliced loops formed therein for suspending articles therefrom, which comprises the following steps: (i) weaving a length of reflective hollow braided rope having a plurality of first diagonal directional carriers with a plurality of second diagonal directional carriers, a first end portion, and an opposite second end portion; (ii) mating each of the end portions having a first connecting portion and a second connecting portion mating with said first connecting portion for forming a closed loop; (iii) each said first connecting portion passing diametrically through the corresponding said second connecting portion at a first point thereon to form said closed loop and thereby define an intersecting portion, and (iv) thence each said first connecting portion being inserted into said corresponding second connecting portion at a second point thereon and diametrically passed through said first connecting portion at said intersecting portion to form a knot, such that each said first connecting portion passes concentrically through said corresponding second connecting portion to be captured therein. Each second point is separated from the corresponding said first point by at least one of the first directional carriers and at least one of the second directional carriers immediately adjacent the at least one of the first directional carriers, with the at least one of the first directional carriers crossing over the at least one of the second directional carriers, and each closed loop being connected to one another by an intermediate portion. This method may be used in conjunction with any of the above-identified embodiments of rope.

The present invention also includes a method of making an improved hanger for temporarily suspending articles therefrom, comprising the steps of: (i) weaving a length of hollow braided reflective rope having a plurality of first diagonal directional carriers with a plurality of second diagonal directional carriers, and a first connecting portion with a first end and an opposite second connecting portion with a second end; (ii) positioning the first connecting portion through the second connecting portion at a first point thereon and thence into the second connecting portion at a second point thereon, provided with a locking interweave of carriers about which a first connecting portion knot is formed, then inserting diametrically through an intersecting portion of the first connecting portion within the hollow core of the second connecting portion and concentrically through the second connecting portion to be captured therein; (iii) separating the second point from the first point by at least one of the first directional carriers and at least one of the second directional carriers immediately adjacent the at least one of the first directional carriers, with the at least one of the first directional carriers crossing over the at least one of the second directional carriers; and (iv) passing the second connecting portion into the first connecting portion at a second connecting portion entrance point thereon providing with a locking interweave of carriers about which a first connecting portion knot is formed, then inserting diametrically through an intersecting portion of the first connecting portion within the hollow core of the second connecting portion and being captured concentrically within the first connecting portion to form a closed loop of increasing strength with increasing tensile force upon the closed loop, wherein the rope comprises at least two carriers of rope material and at least one reflective material, which are combined into a form selected from the group consisting of a hollow braided rope, a solid braided rope, a twisted braided rope, and a plaited rope. This method may be used in conjunction with any of the above-identified embodiments of rope.

It is to be understood that the present invention is not limited to the embodiments described above, but encompasses any and all embodiments within the scope of the description and following claims. The reflective rope, hangers, cables, and lifelines disclosed herein are ideal for use in high visibility areas, areas with machine trialing, pump areas, electric motor areas, cable suspension, water line suspension, and high restriction areas.

1. A reflective rope for use in the mining industry comprising the combination of at least one carrier of rope material and at least one reflective material.

2. The reflective rope of claim 1, wherein said at least one carrier of rope material and said at least one reflective material are combined into a form selected from the group consisting of a hollow braided rope, a solid braided rope, a twisted braided rope, and a plaited rope.

3. The reflective rope of claim 2, wherein said reflective material comprises a reflective yarn comprising about 0.5 mm glass beads bonded to polyester filament.

4. The reflective rope of claim 2, wherein said hollow braided rope comprises eight carriers of monofilament flame retardant polypropylene.

5. The reflective rope of claim 2, wherein said rope is treated with a flame retardant.

6. The reflective rope of claim 4, wherein said reflective material is blended into two of said carriers of said polypropylene.

7. The reflective rope of claim 2, wherein at least two of said carriers are marker carriers and wherein said reflective material is blended into said marker carriers.

8. The reflective rope of claim 2, wherein said rope is non-conductive and flame retardant.

9. The reflective rope of claim 2, further comprising:
a hollow braid of eight carriers of monofilament flame retardant polypropylene, wherein said rope has at least two pics per inch of length;
two of said eight carriers are marker carriers; and
a reflective material is blended into said two marker carriers.

10. The reflective rope of claim 9, wherein said reflective material comprises a reflective yarn comprising about 0.5 mm glass beads bonded to polyester filament.

11. The reflective rope of claim 2, also comprising a plurality of directional indicators spaced evenly along said rope and positioned such that said indicators are pointing along the central axis of said rope.

12. A method of making a reflective rope comprising braiding together at least two carriers of rope material, wherein at least one carrier comprises a reflective yarn comprising about 0.5 mm, glass beads bonded to polyester filament, in such a manner as to have at least two pics per inch of length.

13. A method of making a reflective rope for use in the mining industry comprising combining at least one carrier of rope material and at least one reflective material.

14. The method of claim 13, wherein said combination is of at least one carrier of rope material and at least one reflective material into a form selected from the group consisting of a hollow braided rope, a solid braided rope, a twisted braided rope, and a plaited rope.

15. The method of claim 14, wherein said reflective material comprises a reflective yarn comprising about 0.5 mm glass beads bonded to polyester filament.

16. The method of claim 14, wherein said hollow braided rope comprises eight carriers of monofilament flame retardant polypropylene.

17. The method of claim 14, wherein said rope is treated with a flame retardant.

18. The method of claim 16, wherein said reflective material is blended into two of said carriers of said polypropylene.

19. The method of claim 14, wherein at least two of said carriers are marker carriers and wherein said reflective material is blended into said marker carriers.

20. The method of claim 14, wherein said rope is non-conductive and flame retardant.

21. A method of making a reflective rope for use in the mining industry comprising:
braiding into the form of a hollow braid eight carriers of monofilament flame retardant polypropylene, so as to have at least two pics per inch of length,
wherein two of said eight carriers are marker carriers; and
blending a reflective material into said two marker carriers.

22. The method of claim 21, wherein said reflective material comprises a reflective yarn comprising about 0.5 mm glass beads bonded to polyester filament.

23. A safety directional line comprising:
a reflective rope comprising the combination of at least one carrier of rope material and at least one reflective material; and
a plurality of directional indicators spaced evenly along said rope and positioned such that said indicators are pointing along the axis of said line.

24. The safety directional line of claim 23 comprising:
a reflective rope comprising at least one carrier of rope material and at least one reflective material, which are combined into a form selected from the group consisting of a hollow braided rope, a solid braided rope, a twisted braided rope, and a plaited rope.

25. The safety directional line of claim 24, wherein said reflective material comprises a reflective yarn comprising about 0.5 mm, glass beads bonded to polyester filament.

26. The safety directional line of claim 24, wherein
said hollow braided rope comprises eight carriers of monofilament flame retardant polypropylene,
said reflective material is blended into two of said carriers of said polypropylene, and
said rope is has at least two pics per inch of length.

27. An improved safety directional line for underground mining comprising:
a reflective rope;
a pair of fasteners for attaching said rope to a wall;
a plurality of directional indicators, each said directional indicator comprising two identical cone-forming sections each having
a first end and a second end;
a first side wall extending outwardly from said first end to said second end defining a half-conically shaped surface;
a second side wall having a flat surface opposite said conically shaped surface, wherein said cone forming section is semicircular in cross section; and wherein said second side wall is provided with a channel therein extending along the length of said cone-forming section from said first end to said second end; a semicircular end plate having a circular edge and a flat edge integrally formed with said second side wall and having a section removed from said flat edge which is concentric with said channel in said second side wall of said cone-forming section; a plurality of receptor holes along said first side wall and corresponding holes along said channel in said flat surface; a plurality of retaining pins for insertion into said receptor holes; a coupler for joining said cone-forming sections of each said member; whereby,
upon joining said cone-forming sections of each said indicator such that said second side walls, and said first ends and said second ends are adjacent, said coupler is engaged and said cone-forming sections of each said member form a continuous side wall which extends outwardly from said first end to said second end defining a conical outer configuration and an inner wall which defines a circular channel extending through the center of said indicator; said rope being inserted into said circular channel of each said indicator and said retaining pins are inserted in said receptor holes and said holes along said channel and engage said rope.

28. The improved safety directional line of claim 27, wherein said rope comprises at least one carrier of rope material and at least one reflective material, which are combined into a form selected from the group consisting of a hollow braided rope, a solid braided rope, a twisted braided rope, and a plaited rope.

29. The improved safety directional line of claim 28, wherein said reflective material comprises a reflective yarn comprising about 0.5 mm glass beads bonded to polyester filament.

30. The improved safety directional line of claim 28, wherein said rope and said directional indicators are non-conductive and flame retardant.

31. The improved safety directional a line of claim 28, wherein
said pair of fasteners comprises a bronze hook and a bronze ring,
said hook is a swivel hook,
said coupler is an interlocking snap-assembly,
each directional indicator further comprises reflective tape on its continuous side wall along the length of the cone forming sections and further comprises reflective tape in an X shape on said end plate.

32. The improved safety directional line of claim 28, further comprising
eight carriers, and wherein
said rope has at least two pics per inch of length;
two of said eight carriers are marker carriers; and
a reflective material is blended into said two marker carriers.

33. The improved safety directional line of claim 32, wherein said reflective material comprises a reflective yarn comprising about 0.5 mm glass beads bonded to polyester filament.

34. An improved line with double spliced loops formed therein for suspending articles therefrom, comprising:
a length of reflective hollow braided rope having a plurality of first diagonal directional carriers interwoven with a plurality of second diagonal directional carriers, a first end portion, and an opposite second end portion;
each said end portion having a first connecting portion and a second connecting portion mating with said first connecting portion for forming a closed loop;
each said first connecting portion passing diametrically through the corresponding said second connecting portion at a first point thereon to form said closed loop and thereby define an intersecting portion, and thence each said first connecting portion being inserted into said corresponding second connecting portion at a second point thereon and diametrically passed through said first connecting portion at said intersecting portion to form a knot, such that each said first connecting portion passes concentrically through said corresponding second connecting portion to be captured therein;
each said second point being separated from the corresponding said first point by at least one of said first directional carriers and at least one of said second directional carriers immediately adjacent said at least one of said first directional carriers, with said at least one of said first directional stands crossing over said at least one of said second directional carriers; and
each said closed loop being connected to one another by an intermediate portion.

35. The improved line with double spliced loops of claim 34, wherein said rope comprises at least one carrier of rope material and at least one reflective material, which are combined into a form selected from the group consisting of a hollow braided rope, a solid braided rope, a twisted braided rope, and a plaited rope.

36. The improved line with double spliced loops of claim 35, wherein said reflective material comprises a reflective yarn comprising about 0.5 mm glass beads bonded to polyester filament.

37. The improved line with double spliced loops of claim 35, wherein
said hollow braided rope comprises eight carriers of monofilament flame retardant polypropylene,
said rope is non-conductive,
said rope has at least two pics per inch of length, and
said reflective material comprises a reflective yarn comprising 0.5 mm, glass beads bonded to polyester filament.

38. An improved hanger for temporarily suspending articles therefrom, comprising:
a length of hollow braided reflective rope having a plurality of first diagonal directional carriers interwoven with a plurality of second diagonal directional carriers, and a first connecting portion with a first end and an opposite second connecting portion with a second end;
said first connecting portion being positioned diametrically through said second connecting portion at a first point thereon and thence into said second connecting portion at a second point thereon, provided with a locking interweave of carriers about which a first connecting portion knot is formed, then inserted diametrically through an intersecting portion of the first connecting portion within the hollow core of the second connecting portion and concentrically through said second connecting portion to be captured therein;
said second point being separated from said first point by at least one of said first directional carriers and at least one of said second directional carriers immediately adjacent said at least one of said first directional carriers, with said at least one of said first directional carriers crossing over said at least one of said second directional carriers; and
said second connecting portion passing into said first connecting portion at a second connecting portion entrance point thereon providing with a locking interweave of carriers about which a first connecting portion knot is formed, then inserting diametrically through an intersecting portion of the first connecting portion within the hollow core of the second connecting portion and being captured concentrically within said first connecting portion to form a closed loop of increasing strength with increasing tensile force upon said closed loop, wherein said rope comprises at least one carrier of rope material and at least one reflective material, which are combined into a form selected from the group consisting of a hollow braided rope, a solid braided rope, a twisted braided rope, and a plaited rope.

39. The improved hanger of claim 38, wherein said reflective material comprises a reflective yarn comprising about 0.5 mm glass beads bonded to polyester filament.

40. The improved hanger of claim 38, wherein
said hollow braided rope comprises eight carriers of monofilament flame retardant polypropylene,
said rope is non-conductive,
said rope has two pics per inch of length, and
said reflective material comprises a reflective yarn comprising about 0.5 mm glass beads bonded to polyester filament.

41. The improved hanger of claim 38, including at least one article support installed thereon.

42. The improved hanger of claim 41, wherein said at least one article support is selected from the group consisting of an S-hook, a snap hook, a spring hook and a D-ring.

43. A hanger comprising:
a rope comprising at least two carriers of material, which are braided together, wherein at least one carrier comprises a reflective yarn comprising about 0.5 mm glass beads bonded to polyester filament.

44. A hanger for use in the mining industry comprising the combination of at least one carrier of rope material and at least one reflective material.

45. The hanger of claim 44, wherein said at least one carrier of rope material and said at least one reflective material are combined into a form selected from the group consisting of a hollow braided rope, a solid braided rope, a twisted braided rope, and a plaited rope.

46. The hanger of claim 45, wherein said reflective material comprises a reflective yarn comprising about 0.5 mm glass beads bonded to polyester filament.

47. The hanger of claim 45, wherein
said hollow braided rope comprises eight carriers of monofilament flame retardant polypropylene,
said rope is non-conductive,
said rope is assembled to have at least two pics per inch of length, and
said reflective material comprises a reflective yarn comprising about 0.5 mm glass beads bonded to polyester filament.

48. A method of making a safety directional line comprising
braiding together at least one carrier of rope material and a reflective yarn comprising about 0.5 mm glass beads bonded to polyester filament, in such a manner as to have at least two pics per inch of length; and
attaching a plurality of directional indicators spaced evenly along said rope and positioned such that said indicators are pointing along the axis of said line.

49. A method of making a safety directional line for use in the mining industry comprising:
combining at least one carrier of rope material and at least one reflective material; and
attaching a plurality of directional indicators spaced evenly along said rope and positioned such that said indicators are pointing along the axis of said line.

50. The method of claim 49, wherein said at least one carrier of rope material and said at least one reflective material are combined into a form selected from the group consisting of a braided rope with a hollow center, a solid braided rope, a twisted braided rope, and a plaited rope.

51. A method of making an improved line with double spliced loops formed therein for suspending articles therefrom, comprising:
weaving a length of reflective hollow braided rope having a plurality of first diagonal directional carriers with a plurality of second diagonal directional carriers, a first end portion, and an opposite second end portion;
mating each of said end portion having a first connecting portion and a second connecting portion mating with said first connecting portion for forming a closed loop;
each said first connecting portion passing diametrically through the corresponding said second connecting portion at a first point thereon to form said closed loop and thereby define an intersecting portion, and thence each said first connecting portion being inserted into said corresponding second connecting portion at a second point thereon and diametrically passed through said first connecting portion at said intersecting portion to form a knot, such that each said first connecting portion passes concentrically through said corresponding second connecting portion to be captured therein;
each said second point being separated from the corresponding said first point by at least one of said first directional carriers and at least one of said second directional carriers immediately adjacent said at least one of said first directional carriers, with said at least one of said first directional stands crossing over said at least one of said second directional carriers; and
each said closed loop being connected to one another by an intermediate portion.

52. The method of claim 51, wherein said rope comprises at least one carrier of rope material and at least one reflective material, which are combined into a form selected from the group consisting of a hollow braided rope, a solid braided rope, a twisted braided rope, and a plaited rope.

53. An method of making an improved hanger for temporarily suspending articles therefrom, comprising:
weaving a length of hollow braided reflective rope having a plurality of first diagonal directional carriers with a plurality of second diagonal directional carriers, and a first connecting portion with a first end and an opposite second connecting portion with a second end;
positioning said first connecting portion through said second connecting portion at a first point thereon and thence into said second connecting portion at a second point thereon, provided with a locking interweave of carriers about which a first connecting portion knot is formed, then inserting diametrically through an intersecting portion of the first connecting portion within the hollow core of the second connecting portion and concentrically through said second connecting portion to be captured therein;
separating said second point from said first point by at least one of said first directional carriers and at least one of said second directional carriers immediately adjacent said at least one of said first directional carriers, with said at least one of said first directional carriers crossing over said at least one of said second directional carriers; and
passing said second connecting portion into said first connecting portion at a second connecting portion entrance point thereon providing with a locking interweave of carriers about which a first connecting portion knot is formed, then inserting diametrically through an intersecting portion of the first connecting portion within the hollow core of the second connecting portion and being captured concentrically within said first connecting portion to form a closed loop of increasing strength with increasing tensile force upon said closed loop, wherein said rope comprises at least two carriers of rope material and at least one reflective material, which are combined into a form selected from the group consisting of a hollow braided rope, a solid braided rope, a twisted braided rope, and a plaited rope.
